(19) United States
(12) Patent Application Publication
(10) Pub. No.: US 2013/0033007 A1
(43) Pub. Date: Feb. 7, 2013

(54) High Temperature Seal

(71) Applicants: Heinrich Pauli, Graz (AT); Wolfgang Plienegger, Semriach (AT); Gottfried Schiffer, Graz (AT)

(72) Inventors: Heinrich Pauli, Graz (AT); Wolfgang Plienegger, Semriach (AT); Gottfried Schiffer, Graz (AT)

(21) Appl. No.: 13/566,210

(22) Filed: Aug. 3, 2012

(30) Foreign Application Priority Data
Aug. 5, 2011 (AT) A 1134/2011

(51) Int. Cl. F16J 15/16

(52) U.S. Cl. 277/406

(57) ABSTRACT

The invention relates to a high-temperature seal (1) with a sealing ring (5) and a counter-ring (6), characterized by the sealing ring (5) and counter-ring (6) being made of metal. As a result, good contact is achieved with good sealing effect, also at high temperatures. It is an advantage if the sealing ring (5) is made of a high-grade steel and/or the counter-ring (6) is made of a CuNi alloy.

The invention relates to a high-temperature seal with a sealing ring and a counter-ring. In addition, the invention relates to a rotating tubular reactor with a high-temperature seal.

In devices in which high temperatures occur during operation, for example rotating tubular reactors or drum driers, there is the recurring problem of how to seal off the rotating parts, particularly the drum, towards the stationary parts, such as corresponding feed connections or covers for gases. So additional air is often sucked in through gaps and the drum must therefore be kept under a slight vacuum compared to the surrounding atmosphere. This additional air reduces the heating capacity of the drying or heating gases and makes additional heating input necessary. At these high temperatures, ceramic seals are mainly used, however they are brittle and difficult to change.

The aim of the invention is thus to create a sealing system for use at high temperatures that is stable and seals well at all temperatures.

The invention is thus characterized by the sealing ring and the counter-ring being made of metal. As a result, the parts can also slide over one another at high temperatures without leaving gaps.

A favorable further embodiment of the invention is thus characterized by the sealing ring being pressed onto the counter-ring by a pressure-loading ring. The pressing force can be controlled effectively by means of this pressure-loading ring.

An advantageous further embodiment of the invention is characterized by the sealing ring being stationary and the counter-ring rotating. In this way, the forces acting on the sealing ring can be set very effectively.

A favorable embodiment of the invention is characterized by the sealing ring being pressed onto the counter-ring by means of an expansion joint, particularly using a pressure-loading ring. Due to the pre-loading, the pressing force can be controlled accordingly and any axial movement and temperature expansion between the rotating and the stationary part can also be compensated.

An advantageous embodiment of the invention is characterized by the sealing ring being clamped to the pressure-loading ring. This ensures that the sealing ring slides over the counter-ring.

The invention also relates to a rotating tubular reactor with a high-temperature seal according to the invention. The rotating tubular reactor is characterized by the counter-ring being secured to the reactor drum and the drum rotating during operation, where the sealing ring is connected preferably to the stationary part.

It is particularly favorable if a high-temperature seal is provided at least at both ends of the rotating tubular reactor.

In the following, the invention is exemplified on the basis of the drawings, where

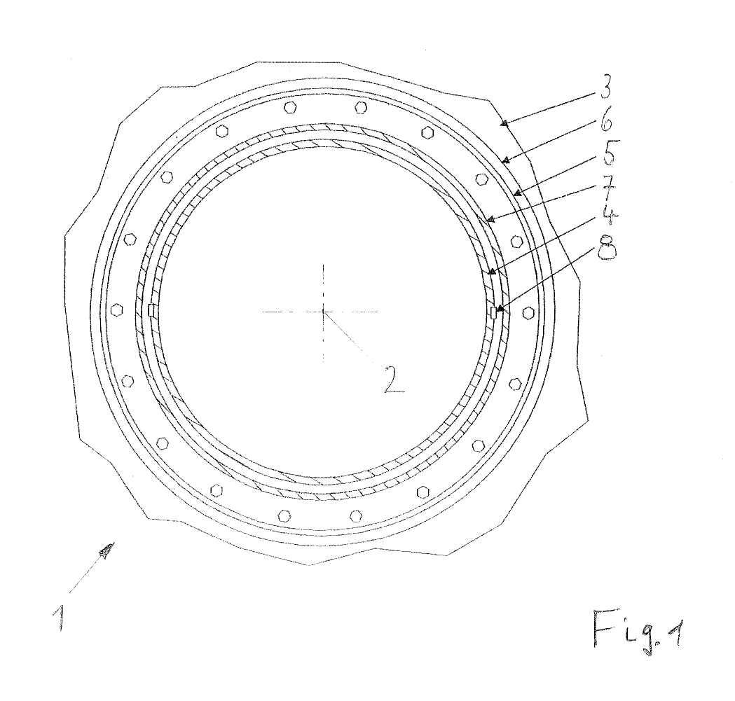

FIG. 1 shows a view of a seal arrangement according to the invention,

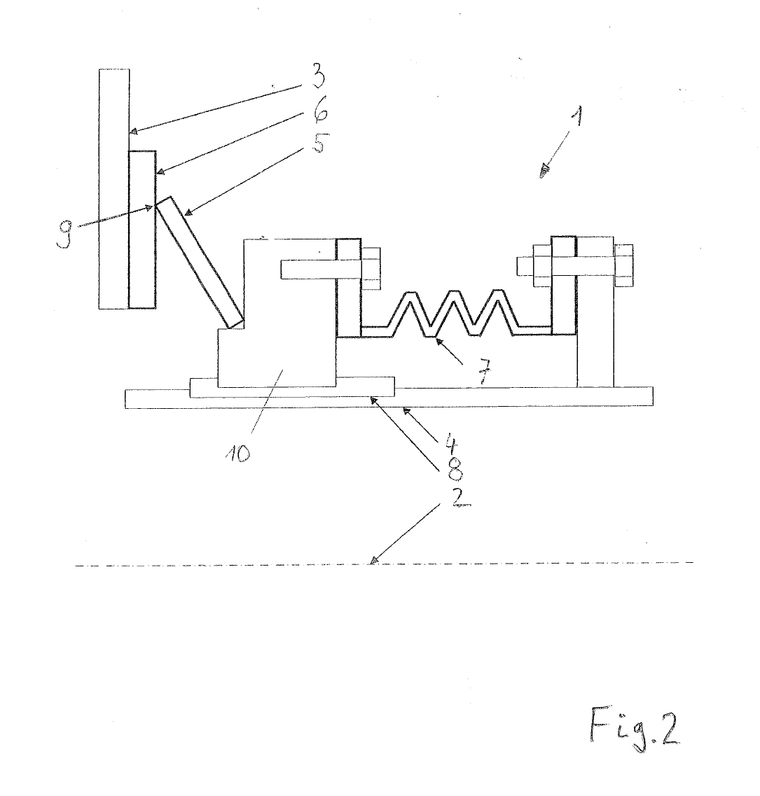

FIG. 2 shows a sectional view of a seal arrangement according to the invention,

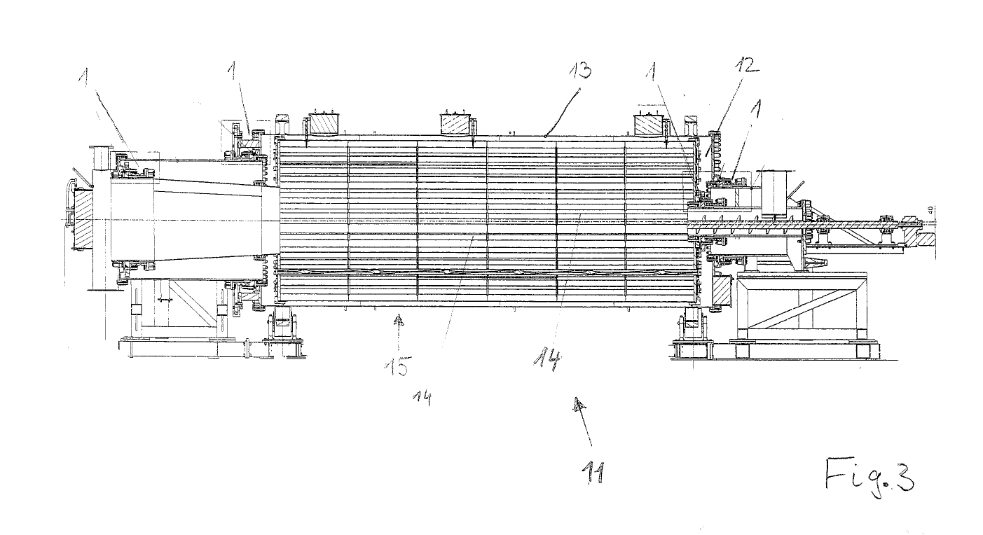

FIG. 3 shows a view of a rotating tubular reactor with high-temperature seal according to the invention, and

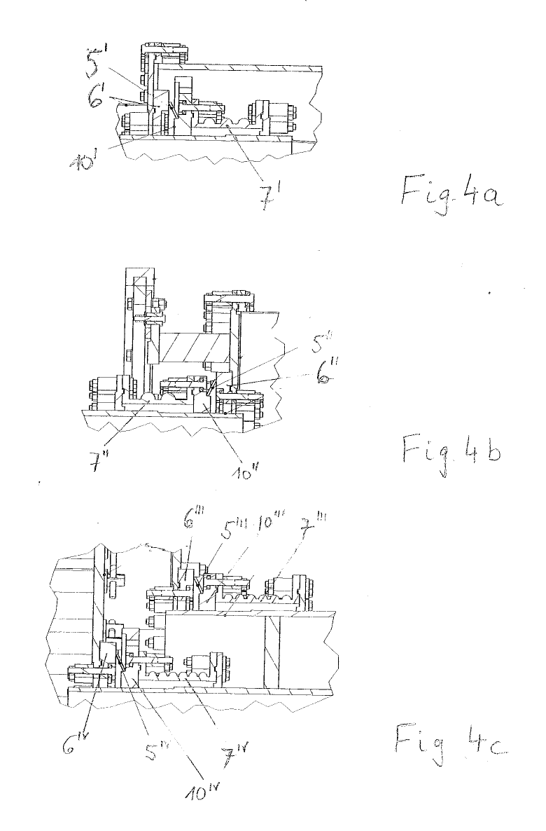

FIGS. 4a, b, and c show details of a seal arrangement at the rotating tubular reactor in FIG. 3.

FIG. 1 shows an arrangement of a high-temperature seal 1 according to the invention between a part 3 rotating round a central axis 2 and which can be a rotating tubular reactor or a heated drying drum, for example, and a stationary part 4, for example a feed connection for a material feed and a connection for feeding in a heating gas, e.g. flue gas. Here, a sealing ring 5 on the stationary part 4 is pressed onto a counter-ring 6 on the rotating part 3. An expansion joint 7 is used for pre-loading and to compensate for any axial movement and expansion. Feather keys 8 (for example two or more distributed over the circumference) prevent the expansion joint 7 from having to absorb the torque occurring due to the frictional force of the sealing ring 5 acting on the sliding surface 9 of the counter-ring 6.

FIG. 2 shows a high-temperature seal 1 according to the invention, where identical parts have identical reference numerals. The key element of the high-temperature seal 1 is the sealing ring 5, which is made, for example, from a high-grade steel. The sealing ring 5 is located on the stationary part 4 and thus does not rotate. The expansion joint 7 is preferably designed as a metal expansion joint and presses the sealing ring 5 onto the counter-ring 6 via a pressure-loading ring 10. The expansion joint 7 is pre-loaded accordingly for this purpose. In addition, it compensates for any movement in axial direction and temperature expansion between the rotating part 3 and the stationary part 4. The counter-ring 6, for example, is made of a soft Cu—Ni alloy, is secured to the rotating part 3 and forms the sliding and sealing surface 9 together with the sealing ring 5. As the sliding and sealing surface 9 is at right angles to the central axis 2, this sealing surface 9 is able to compensate for any radial movement and temperature expansion. Due to the pre-loading force of the expansion joint 7, the sealing ring 5 changes its incline slightly and the inner diameter becomes slightly smaller. If the material of the sealing ring 5 has a lower temperature expansion coefficient than the material of the pressure-loading ring 10, the sealing ring 5 is then clamped to the pressure-loading ring 10. This ensures that the sealing ring 5 slides on the counter-ring 6 instead of on the pressure-loading ring 10.

FIG. 3 now shows a rotating tubular reactor 11 that is heated by means of flue gas, where the flue gas is fed into a chamber 12 and heats material inside the drum 15 via a double shell 13 and heating tubes 14, respectively. The flue gas here has temperatures of up to 450° C., while the material inside the drum 15 is heated up to approximately 400° C. In order to guarantee that there are no leaks, two high-temperature seals 1 each are provided at either end of the drum 15.

FIG. 4a shows the installation situation at the material discharge area, where the sealing ring 5′ is pressed against the counter-ring 6′ via an expansion joint 7′ and a pressure-loading ring 10′. The situation at the outer circumference of the rotating tubular reactor 11 is shown in FIG. 4b. Here, the sealing ring 5″ is pressed against the counter-ring 6″ via an expansion joint 7″ and a pressure-loading ring 10″. FIG. 4c shows the installation situation at the material feed, where two high-temperature seals 1 according to the invention are used here at the same time. At the outer seal, the sealing ring 5″' is pressed against the counter-ring 6″' via an expansion joint 7″ and a pressure-loading ring 10″, while at the inner seal surrounding the material feed connection, the sealing ring 5^{IV} is pressed against the counter-ring 6^{IV} via an expansion joint 7′ and a pressure-loading ring 10^{IV}.

In addition to rotating tubular reactors and drum driers, the high-temperature seal according to the invention can be used in all applications where rotating parts have to be sealed off against stationary parts at high temperatures (over 80 to 100° C. and up to 1200° C.).

1. A high-temperature seal with a sealing ring (5) and a counter-ring (6), wherein the sealing ring (5) and the counter-ring (6) are made of metal.

2. The high-temperature seal according to claim 1, wherein the sealing ring (5) is made of a high-grade steel.

3. The high-temperature seal according to claim 1, wherein the counter ring (6) is made of a CuNi alloy.

4. The high-temperature seal according to claim 1, wherein the sealing ring (5) is pressed onto the counter-ring (6) by a pressure-loading ring (10).

5. The high-temperature seal according to claim 1, wherein the sealing ring (5) is stationary and the counter-ring (6) rotates.

6. The high-temperature seal according to claim 1, wherein the sealing ring (5) is pressed onto the counter-ring (6) by a pressure-loaded expansion joint (7).

7. The high-temperature seal according to claim 4, wherein the sealing ring (5) is joined to the pressure-loading ring (10) by heat-shrink interference clamping

8. The high-temperature seal according to claim 2, wherein the counter ring (6) is made of a CuNi alloy.

9. The high-temperature seal according to claim 4, wherein the sealing ring (5) is stationary and the counter-ring (6) rotates.

10. The high-temperature seal according to claim 4, wherein the sealing ring (5) is pressed onto the counter-ring (6) by a pressure-loaded expansion joint (7).

11. The high-temperature seal according to claim 5, wherein the sealing ring (5) is pressed onto the counter-ring (6) by a pressure-loaded expansion joint (7).

12. The high-temperature seal according to claim 11, wherein the sealing ring (5) is joined to the pressure-loading ring (10) by a heat-shrink interference fit.

13. The high-temperature seal according to claim 10, wherein the sealing ring (5) is stationary and the counter-ring (6) rotates.

14. The high-temperature seal according to claim 8, wherein the sealing ring (5) is stationary and the counter-ring (6) rotates.

15. The high-temperature seal according to claim 7, wherein the sealing ring (5) is pressed onto the counter-ring (6) by a pressure-loaded expansion joint (7).

16. A rotating tubular reactor having a reactor drum (3, 15) that rotates around a stationary part (4) with an interposed high temperature seal (1) having a sealing ring (5) bearing on a counter-ring (6), wherein the sealing ring (5) is made of metal and carried on the stationary part, and the counter-ring (6) is made of metal and carried on the rotating drum

17. The tubular reactor of claim 16, wherein the sealing ring (5) is pressed onto the counter-ring (6) by a pressure-loading ring (10)

18. The tubular reactor of claim 17, wherein the sealing ring (5) is pressed onto the counter-ring (6) by a pressure-loaded expansion joint (7) The tubular reactor of claim 16, wherein the sealing ring (5) is joined to the pressure-loading ring (10) by a heat-shrink interference fit
